(19) United States
(12) Patent Application Publication
(10) Pub. No.: US 2006/0150835 A1
(43) Pub. Date: Jul. 13, 2006

(54) Method for driving rollers of a printing unit of a printing press

(75) Inventors: Peter Heiler, Forst (DE); Holger Leonhardt, Meckesheim (DE); Peter Palmen, Leimen (DE); Roland Vay, Eberbach (DE); Andreas Alexander, Leimen (DE); Rolf Spilger, Viernheim (DE)

Correspondence Address: LERNER GREENBERG STEMER LLP, P O BOX 2480, HOLLYWOOD, FL, 33022-2480, US

(73) Assignee: Heidelberger Druckmaschinen AG

(21) Appl. No.: 11/172,009

(22) Filed: Jun. 30, 2005

(30) Foreign Application Priority Data
Jun. 30, 2004 (DE) 10 2004 031 946.4

(51) Int. Cl. B41L 25/00

(52) U.S. Cl. 101/148

(57) ABSTRACT

A method for driving rollers of a printing unit of a printing press, includes driving at least two of the rollers at different speeds for transferring liquid. A change in the torque on one of the rollers is determined. A drive for at least one of the rollers is set in dependence on the change in the torque.

### BACKGROUND OF THE INVENTION

1. Field of the Invention

The invention relates to a method for driving rollers of a printing unit of a printing press, wherein at least two rollers are driven at different speeds for transferring liquid.

A printing unit of a wet offset printing press has an inking unit and a dampening unit provided with transfer and applicator rollers for printing ink and dampening solution. German Published, Non-prosecuted Patent Application DE 196 45 169 A1 discloses a printing unit having an inking unit roller train and a dampening unit roller train. In that device, besides a dampening solution ductor, all the rollers have a drive connection to a plate cylinder and a rubber-covered cylinder. The dampening solution ductor has a separate controllable-speed drive. A spraying device for cleaning fluid and a doctor device are provided in order to clean all of the rollers and cylinders. When cleaning the cylinders and rollers, initially all of the rollers of the inking unit roller train are cleaned. Thereafter, a dampening solution applicator roller is coupled to the inking unit roller train by a bridging roller. Then, with the spraying device and the doctor device activated, the dampening solution ductor is operated for a limited time at a peripheral speed which is above the peripheral speed that is usual during the printing operation. At the same time, the machine speed of the printing unit is set to a rotational speed at which the peripheral speed of the dampening solution applicator roller driven by the plate cylinder is synchronized with the peripheral speed of the dampening solution ductor. That is intended to ensure that, during the cleaning of the rollers and the cylinders, external friction is maintained and a decrease in the transferable peripheral force in the roller pairing is avoided.

Due to the required synchronism of the dampening solution ductor with the dampening solution applicator roller, the drive of the dampening solution ductor must be controlled as a function of the difference in the rotational angle or rotational speed between the rollers. Rotary encoders are suitable as detectors for the measurement of the actual value of the peripheral speeds.

### SUMMARY OF THE INVENTION

It is accordingly an object of the invention to provide a method for driving rollers of a printing unit of a printing press, which overcomes the hereinafore-mentioned disadvantages of the heretofore-known methods of this general type and which affords flexible control of various operating procedures.

With the foregoing and other objects in view, there is provided, in accordance with the invention, a method for driving rollers of a printing unit of a printing press. The method comprises driving at least two of the rollers at different speeds for transferring liquid. A change in the torque on one of the rollers is determined. A drive for at least one of the rollers is set depending upon the change in the torque.

In accordance with another mode of the inventive method, the printing unit is an offset printing unit having at least one dampening solution transfer roller and a dampening solution dip roller. The method includes, during a cleaning of inking unit and dampening unit rollers, driving the dampening solution transfer roller, together with inking unit rollers, by a first motor. The dampening solution dip roller is driven by a second motor. The torque on the dampening solution dip roller is determined.

In accordance with a further mode, the method includes operating the second motor in braking operation.

In accordance with an added mode, the method further includes, during braking with the second motor, measuring electrical variables, and determining a change in the torque from the measurement of the electrical variables.

In accordance with an additional mode, the method further includes predetermining a limiting value for the torque. A signal for ending the cleaning operation is derived if the limiting value is exceeded.

In accordance with yet another mode, the method further includes, for cleaning, feeding a liquid cleaning agent to the rollers of the inking unit or the dampening unit under pressure through a spray pipe. A limiting value for the torque is predetermined and a signal for beginning to supply the cleaning agent is derived, if the limiting value for the torque is exceeded.

In accordance with yet a further mode, the method further Includes predetermining a limiting value for the torque, and, if the limiting value is exceeded, changing the rotational speed of one of the rollers.

In accordance with yet an added mode, the method further includes throwing the two rollers revolving at different speeds onto one another. A limiting value for the torque as a function of the material of the covers of the two rollers is predetermined.

In accordance with yet an additional mode, the method further includes introducing into a control device characteristic numbers typifying the rollers. The limiting value is derived with the aid of the characteristic numbers.

In accordance with another mode, the method further includes reading out identifiers typifying the rollers and entering them into a control device. The limiting value is derived with the aid of the identifiers.

In accordance with a further mode, the method further includes predetermining a limiting value for the torque. A time period during which the limiting value is exceeded is registered.

In accordance with an alternate mode, the method further includes determining the change in the torque as a function of machine parameters.

In accordance with another alternate mode, the method further includes determining the change in the torque as a function of the temperature in the printing unit.

In accordance with a further alternate mode, the method further includes determining the change in the torque as a function of a system voltage of motors driving the rollers.

In accordance with an added mode, the method further includes throwing the two rollers revolving at different speeds onto one another. The drive for at least one of the rollers is set so that the friction between the two rollers is changed.

In accordance with an additional mode, the method further includes adding a fluid into the contact region of the two thrown-on rollers for reducing friction therebetween.

In accordance with an alternate mode, the method further includes reducing the pressure between the thrown-on rollers so as to reduce the friction therebetween.

In accordance with another alternate mode, the method further includes reducing the absolute speed of the thrown-on rollers so as to reduce the friction therebetween.

In accordance with yet another mode, the method further includes increasing the rotational speed of one of the thrown-on rollers until the torque has reached a predefined value.

In accordance with a concomitant mode, the method further includes providing an offset printing unit having inking and dampening unit rollers and a cleaning configuration for the rollers. A signal for deaeration of lines containing a supply of liquid cleaning agent in the offset printing unit is generated by the change in the torque.

Thus, according to the invention, the torque of at least one of the rollers is monitored. A drive for this roller or a roller having a drive connection to this roller is set depending upon the torque curve or course of the roller. The drive is set in such a manner that a defined slippage is produced between the driven roller and one or more thrown-on rollers. In order to produce the slippage, a specific moment is required when the rollers have a damp surface. This moment can be applied with a drive motor which is operated with a braking current. If the friction between the rollers increases, the braking torque to be applied by the drive motor then rises. When the rollers are wet or damp, a drive moment is required which reduces with increasing drying of the roller surfaces, because of the increasing frictional force, until ultimately a braking moment has to be applied in order to attain a desired slippage.

It is advantageous to limit the braking moment of a drive to a predefined value. The instant the drive exceeds the limiting value, a signal is generated in a control device for the operation of the printing press. In particular, by the use of the signal, a cleaning cycle for the rollers can be ended or the pressure between rollers can be changed through an actuator. It is also possible for the supply of cleaning agent to be controlled by evaluating the braking moment in the control device. Therefore, the quality of the cleaning operation is improved, the cleaning time is shortened and the consumption of cleaning agent is reduced.

For the case wherein the exceeding of a limiting value of a braking torque of a drive motor is evaluated, the limiting value can be defined in accordance with various methods. One possibility is to predefine a maximum braking moment by a machine control system. For this purpose, entries can be made by an operator or automatically through interfaces. For example, data which relate to the material on the surface of the rollers can be processed. Furthermore, the characteristic number of the employed roller type can be entered. It is also possible to determine roller properties by detectors which evaluate a physical property of the roller surface or read the data from identifiers connected to the rollers.

Monitoring the torque of one of the rollers can be made dependent upon the condition of the printing press. For example, the time period during which a limiting moment is exceeded can be evaluated. Furthermore, the torque can be monitored as a function of the printing unit temperature or of the system or mains voltage.

The drive for at least one of the rollers can be set in various ways depending upon the torque. If an electric motor is used, the current, the voltage, the frequency or pulse characteristic variables can be changed. In this regard, the drive relationships can be set by reducing the friction between rollers by changing the coefficients of friction by adding ink, dampening solution or cleaning agent or by reducing the contact pressure between the rollers or by reducing the absolute speed of the two rollers.

In accordance with the method of the invention, the cleaning time can be reduced by increasing, during cleaning, the speed of the machine and therefore the speed of the rollers to be cleaned, until a predefined level of friction is established between two rollers. When the predefined level of friction has been reached, the cleaning operation is completed.

Other features which are considered as characteristic for the invention are set forth in the appended claims.

Although the invention is illustrated and described herein as embodied in a method for driving rollers of a printing unit of a printing press, it is nevertheless not intended to be limited to the details shown, since various modifications and changes may be made therein without departing from the spirit of the invention and within the scope and range of equivalents of the claims.

The method of operation of the invention, however, together with additional objects and advantages thereof will be best understood from the following description of specific modes of operation thereof when read in connection with the accompanying drawings.

### BRIEF DESCRIPTION OF THE DRAWINGS

FIG. 1 is a diagrammatic, side-elevational view of a printing unit of a wet offset printing press; and

FIG. 2 is a schematic and block diagram relating to the monitoring and driving of rollers and cylinders of the printing unit according to FIG. 1.

### DESCRIPTION OF THE PREFERRED EMBODIMENTS

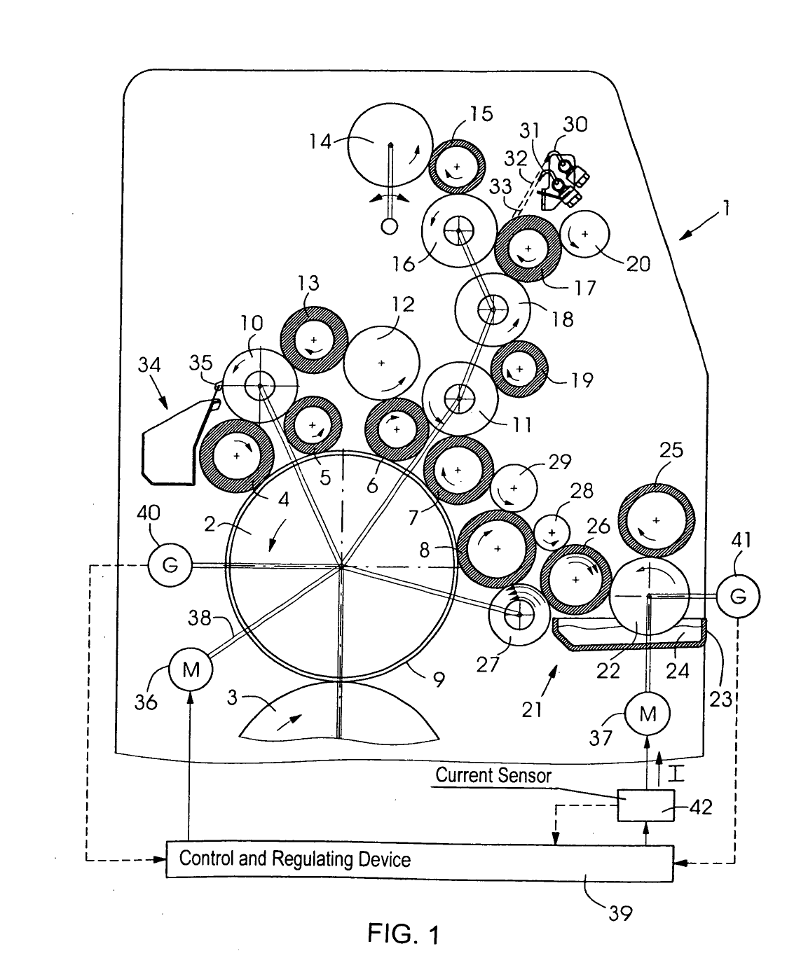

Referring now to the figures of the drawings in detail and first, particularly, to FIG. 1 thereof, there is seen a diagrammatic, side-elevational view of a printing unit 1 of a wet offset printing press. The printing unit 1 is made up of a printing form cylinder 2, a transfer cylinder 3, an impression cylinder, ink applicator rollers 4 to 7 and a dampening solution applicator roller 8. The ink applicator rollers 4 to 7 and the dampening solution applicator roller 8 can be thrown onto a printing form 9 which is clamped on the printing form cylinder 2. The ink applicator rollers 4 and 5, on one hand, and 6 and 7, on the other hand, are in rolling contact with respective ink transfer rollers 10 and 11. The ink applicator roller 6 is in rolling contact with a further ink transfer roller 12. An ink transfer roller 13 bridges the ink transfer rollers 10 and 12. Furthermore, the printing unit 1 has an ink duct or fountain and an ink duct or fountain roller, both non-illustrated, as well as an ink ductor roller 14, which is reciprocatingly movable between the ink duct or fountain roller and an ink transfer roller 15. The ink transfer roller 15 is followed in rolling contact by further ink transfer rollers 16 to 19, an ink distributor roller 20 being thrown onto the ink transfer roller 17, and the ink transfer roller 19 making contact with the ink transfer roller 11.

A dampening unit 21 is provided which includes a dampening solution dip roller 22 projecting into a dampening solution container 23 which is filled with dampening solution 24 during printing. A dampening solution metering roller 25 and a dampening solution transfer roller 26 are thrown onto the dampening solution dip roller 22. Furthermore, the dampening unit 21 includes respective dampening solution transfer rollers 27 in rolling contact with the dampening solution transfer roller 26 and the dampening solution applicator roller 8. A bridging roller 29 connects the dampening solution applicator roller 8 and the ink applicator roller 7. In order to clean the rollers and cylinders of the printing unit 1, spraying devices 30 and 31, for water 32 and a cleaning agent 33, and a doctor blade device 34 having a doctor blade 35, are provided. Nozzles of the spraying devices 30 and 31 are directed towards the surface of the ink transfer roller 17. The doctor blade 35 is to be set against the ink transfer roller 10.

Two motors 36 and 37 are provided for driving the rollers and cylinders of the printing unit 1. The motor 36 is the main drive motor of the wet offset printing press and feeds a torque into a drive gear train, to which the printing form cylinder 2, the transfer cylinder 3, the ink transfer rollers 10, 11, 16 and 18 and the dampening solution transfer roller 27 are connected. A drive connection between the rollers and cylinders and the respective motors 36 and 37 is symbolically illustrated by thin double lines 38. The motor 37 represents an auxiliary drive having a drive connection to the dampening solution dip roller 22. The ink applicator rollers 4 to 7, the dampening solution applicator roller 8, the ink transfer rollers 12, 13, 15, 17 and 19, the ink distributor roller 20, the dampening solution transfer rollers 26 and 27, the dampening solution metering roller 25 and the bridging roller 29 are respectively driven by friction from the respectively adjacent actively driven rollers and the printing form cylinder 2.

The motors 36 and 37 are connected to a control and regulating device 39. Rotational movement of the printing form cylinder 2 and of the dampening solution dip roller 22 is registered by rotary encoders 40 and 41, which are connected to the control and regulating device 39. A current sensor 42 having an output signal proportional to the torque or drive moment present on the dampening solution dip roller 22 is disposed in a feed line between the control and regulating device 39 and the motor 37. An output from the current sensor 42 is connected to the control and regulating device 39.

Both during printing and during cleaning of the rollers and cylinders of the printing unit 1, the motors 36 and 37 are driven in such a manner that slippage is produced between the dampening solution dip roller 22 and the adjacent dampening solution transfer roller 26. During printing, the slippage is, for example, 75%, whereas during cleaning, the slippage is set to about 30%. Since the dampening solution transfer roller 26 is located between the dampening solution transfer roller 27 rotating at high speed and the dampening solution dip roller 22 rotating at lower speed, the dampening solution transfer roller 26 has an average rotational speed dependent upon the pressure with respect to the dampening solution transfer roller 27 and the dampening solution dip roller 22.

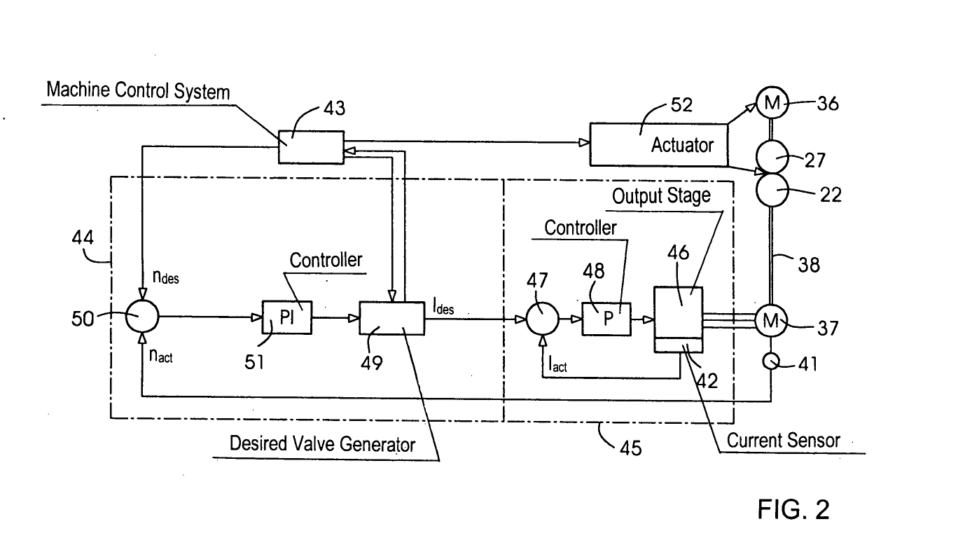

The control and monitoring of the motors 36 and 37 is illustrated in greater detail in FIG. 2. Within the control and regulating device 39, in addition to a machine control system 43, there is provided a drive control system 44 and a power section 45 for the motor 37. The power section 45 includes an output stage 46 which supplies a current I, so that the motor 37 brakes the dampening solution dip roller 22. An actual value I_{act} of the current measured by the current sensor 42 is a measure of the braking moment applied to the dampening solution dip roller 22. The actual value I_{act} of the current is supplied to a comparator 47, where it is compared with a desired or nominal value I_{des} formed by the drive control system 44. A differential value between the actual and the desired values of the current is outputted to a controller 48 having a P characteristic. An actuating variable for the output stage 46, which is generated in the controller 48, causes the desired-actual difference in the current to be reduced or eliminated. Assurance is thereby provided that a defined slippage always occurs between the dampening solution dip roller 22 and the dampening solution transfer roller 26.

The desired value I_{des} is predefined based upon various parameters, events and operating modes. For this purpose, a desired value generator 49 is provided in the drive control system 44. The desired value generator 49 has logic elements and/or computational aids for obtaining the desired current value I_{des}, which are connected bidirectionally to the machine control system 43. The machine control system 43 predefines whether the desired current value I_{des} is to be generated for the printing operation or the cleaning operation. The way in which the desired value for the cleaning operation is obtained is discussed below in greater detail.

Desired or nominal rotational speeds for the motors 36 and 37 are predefined by the machine control system 43 for cleaning the rollers and cylinders of the printing unit 1. A desired or nominal rotational speed value n_{des} for the motor 37 is compared with an actual rotational speed value n_{act} in a comparator 50. The actual rotational speed value n_{act} is measured with a rotary encoder 41. The nominal or desired-actual deviation of the rotational speeds n_{des} and n_{act} is supplied to a controller 51 having a PI characteristic. An output signal from the controller 51 forms an input variable for determining the desired or nominal value I_{des} for the current in the desired or nominal value generator 49. A further input variable for determining the desired or nominal value I_{des} is a limiting value for a torque, which is predefined by the machine control system 43. Since the braking moment on the dampening solution dip roller 22 depends directly upon the feed current I for the motor 37, a limiting value for the desired or nominal value I_{des} is derivable from the limiting value for the torque. If the limiting value for the desired or nominal current I_{des} is exceeded, a feedback signal is then generated and processed in the machine control system 43. With the aid of an actuator 52, the machine control system 43 then controls further operations, such as a change in the speed of the motor 36, the actuation of the spraying devices 30 and 31 or the adjustment of the pressure between the dampening solution transfer roller 26 and the dampening solution dip roller 22 and/or the dampening solution transfer roller 27.

Checking the deaeration of the spray pipes of the spraying devices 30 and 31 is afforded by the invention of the instant application. As long as there is only ink and dampening solution 24, respectively, between the rollers thrown on in the printing unit 1, a predetermined moment is required in order to maintain a predefined slippage at the dampening solution dip roller 22. As long as there is air in the feed lines of the spray pipes, the moment will not change. The instant that cleaning agent 33 and water 32, respectively, come onto the rollers, the moment will decrease. This change in the moment can be interrogated in order to generate a signal to the effect that deaeration has taken place.

This application claims the priority, under 35 U.S.C. § 119, of German Patent Application 10 2004 031 946.4, filed Jun. 30, 2004; the entire disclosure of the prior application is herewith incorporated by reference.

We claim:

1. A method for driving rollers of a printing unit of a printing press, which further comprises the following steps:
driving at least two of the rollers at different speeds for transferring liquid;
determining a change in the torque on one of the rollers; and
setting a drive for at least one of the rollers in dependence on the change in the torque.

2. The method according to claim 1, which further comprises:
providing the printing unit as an offset printing unit having at least one dampening solution transfer roller and a dampening solution dip roller;
driving the dampening solution transfer roller, together with inking unit rollers, by a first motor, during a cleaning of inking unit and dampening unit rollers;
driving the dampening solution dip roller by a second motor; and
determining the torque on the dampening solution dip roller.

3. The method according to claim 2, which further comprises operating the second motor in braking operation.

4. The method according to claim 3, which further comprises:
measuring electrical variables during braking with the second motor; and
determining a change in the torque from the measurement of the electrical variables.

5. The method according to claim 2, which further comprises:
predetermining a limiting value for the torque; and
deriving a signal for ending the cleaning operation if the limiting value is exceeded.

6. The method according to claim 2, which further comprises:
feeding a liquid cleaning agent to the rollers of the inking unit or the dampening unit under pressure through a spray pipe, for cleaning;
predetermining a limiting value for the torque; and
deriving a signal for beginning to supply the cleaning agent, if the limiting value for the torque is exceeded.

7. The method according to claim 1, which further comprises:
predetermining a limiting value for the torque; and
changing the rotational speed of one of the rollers if the limiting value is exceeded.

8. The method according to claim 1, which further comprises:
throwing the two rollers revolving at different speeds onto one another; and
predetermining a limiting value for the torque as a function of a material of covers of the two rollers.

9. The method according to claim 8, which further comprises:
introducing characteristic numbers typifying the rollers into a control device; and
deriving the limiting value with the aid of the characteristic numbers.

10. The method according to claim 8, which further comprises:
reading out identifiers typifying the rollers and entering them into a control device; and
deriving the limiting value with the aid of the identifiers.

11. The method according to claim 1, which further comprises:
predetermining a limiting value for the torque; and
registering a time period during which the limiting value is exceeded.

12. The method according to claim 1, which further comprises determining the change in the torque as a function of machine parameters.

13. The method according to claim 12, which further comprises determining the change in the torque as a function of the temperature in the printing unit.

14. The method according to claim 12, which further comprises determining the change in the torque as a function of a system voltage of the motors driving the rollers.

15. The method according to claim 1, which further comprises:
throwing the two rollers revolving at different speeds onto one another; and
setting the drive for at least one of the rollers so that the friction between the two rollers is changed.

16. The method according to claim 15, which further comprises adding a fluid into a contact region of the two thrown-on rollers for reducing friction therebetween.

17. The method according to claim 15, which further comprises reducing pressure between the thrown-on rollers for reducing friction therebetween.

18. The method according to claim 15, which further comprises reducing an absolute speed of the thrown-on rollers for reducing friction therebetween.

19. The method according to claim 1, which further comprises increasing a rotational speed of one of the thrown-on rollers until the torque reaches a predefined value.

20. The method according to claim 1, which further comprises: providing an offset printing unit having inking and dampening unit rollers and a cleaning configuration for the rollers; and
generating, by the change in the torque, a signal for deaeration of lines containing a supply of liquid cleaning agent in the offset printing unit.
